(19) United States
(12) Patent Application Publication
(10) Pub. No.: US 2014/0175814 A1
(43) Pub. Date: Jun. 26, 2014

(54) SECURITY DOOR BLOCK

(71) Applicant: Holsopple Security Solutions LLC, New Paris, IN (US)

(72) Inventor: Darin Holsopple, New Paris, IN (US)

(73) Assignee: HOLSOPPLE SECURITY SOLUTIONS LLC, New Paris, IN (US)

(21) Appl. No.: 14/136,915

(22) Filed: Dec. 20, 2013

Related U.S. Application Data
(60) Provisional application No. 61/745,495, filed on Dec. 21, 2012.

(51) Int. Cl. E05B 13/04

(52) U.S. Cl. CPC E05B 13/04
USPC 292/348

(57) ABSTRACT

A security door block is provided for holding a door handle in the locked position. The security door block includes a first arm and a second arm. The first arm is dimensioned to prevent rotation of the door handle. The second arm is spaced between the door handle and the door jam. The security door block serves as a deterrent to intruders to delay their entry to a room.

### CROSS-REFERENCE TO RELATED APPLICATION

This application claims priority from U.S. Provisional Application No. 61/745,495 filed Dec. 21, 2012, which application is hereby incorporated in its entirety by reference.

### BACKGROUND OF THE INVENTION

The present disclosure is related to a security door block. Previously, there have been many systems which serve to hold a door in the closed position, including door locks, deadbolts, latches, and locking bars. Many of these systems can be overcome by using a key from the outside of the door. Others of these systems can be readily defeated if an intruder can break a window to access the inside of the door. As such, an improved door security system is needed.

### SUMMARY OF THE INVENTION

The present disclosure describes a security door block which is suitable for holding a door handle in the locked position. The security door block includes a first arm and a second arm. The first arm is dimensioned to prevent rotation of the door handle. The second arm is spaced between the door handle and the door jam. The security door block serves as a deterrent to intruders to delay their entry to a room. The security door block described herein is suitable for use in addition to existing door locking systems.

### BRIEF DESCRIPTION OF THE DRAWINGS

A preferred embodiment of this invention has been chosen wherein:

FIG. 1 is a perspective view of a security door lock as carried on a door handle and abutting a door jam;

FIG. 2 is a front view of the security door lock of FIG. 1, prior to being installed on the door handle;

FIG. 3 is a front view of the security door lock of FIG. 1 with a latch moved toward the closed position to allow the barrel of the door handle to pass the latch;

FIG. 4 is a front view of the security door lock of FIG. 1 as installed on a door handle;

FIG. 5 is a front view of the security door lock of FIG. 1;

FIG. 6 is a bottom view of the security door lock of FIG. 5;

FIG. 7 is a cross-sectional view taken along the line 7-7 of the security door lock of FIG. 5; and

FIG. 8 is a perspective view of the security door lock as installed on a door handle and abutting a block.

### DESCRIPTION OF THE PREFERRED EMBODIMENT

The present disclosure describes a security door block 10 having a first arm 12 and a second arm 14. Referring to FIG. 1, the security door block 10 is suitable for use with a door handle 16 and a door jam 18 to hold the door handle 16 in the closed position. The door handle 16 includes three principal parts, a barrel 20, a grasping portion 22 and a tapered end 24. The barrel 20 is the cylindrical portion of the door handle 16 which joins the grasping portion 22 to a door 26. The tapered end 24 is the terminal end of the grasping portion 22 and is angled relative the grasping portion 22 in the direction of the door 26. In use, the first arm 12 is carried between the barrel 20 and the tapered end 24 while the second arm 14 is carried between the barrel 20 and the door jam 18.

The first arm 12 and the second arm 14 are oriented parallel one another. A gap 28 is defined as the space between the first arm 12 and the second arm 14. When the security door block 10 is used with a door handle 16, the barrel 20 is positioned in the gap 28. A spanning portion 30 joins the first arm 12 to the second arm 14. Preferably, the spanning portion 30 is oriented perpendicularly to both the first arm 12 and the second arm 14.

The first arm 12 has a generally rectangular cross-section, being defined by four walls where one of the walls, the latch wall 34, faces the second arm 14.

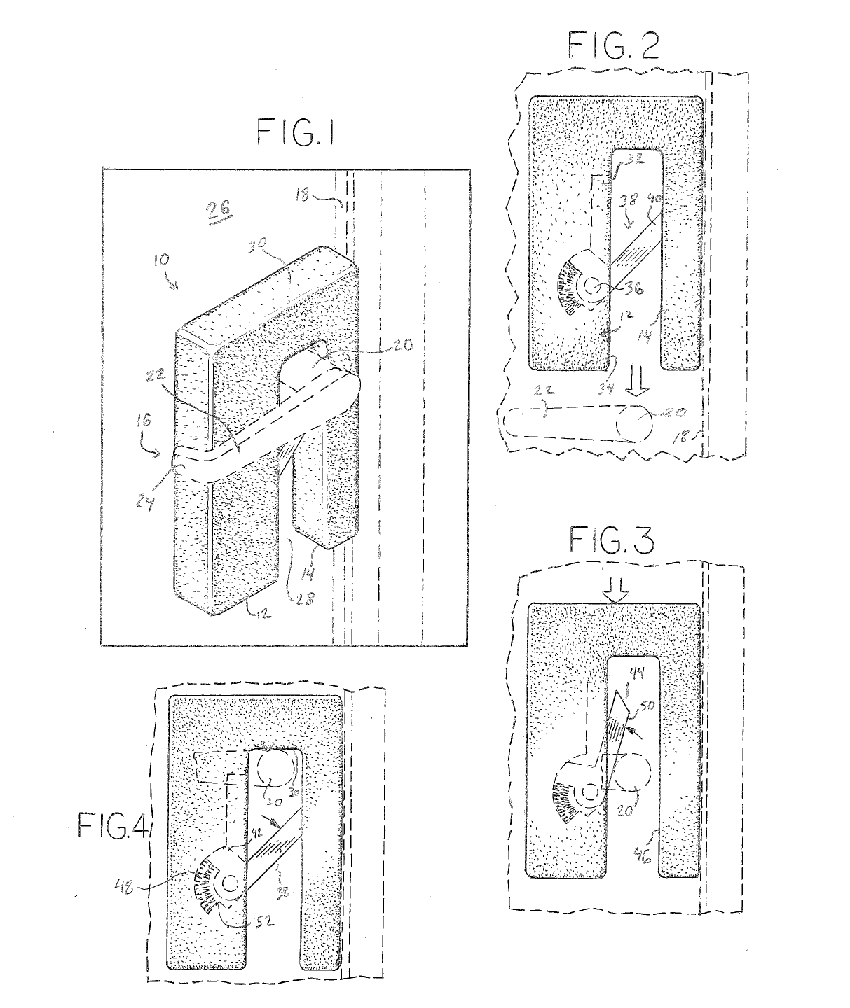

A cavity 32 is defined as a space formed in the first arm 12. The cavity 32 forms an opening in the latch wall 34. A post 36 is positioned in the cavity 32. The post 36 carries a latch 38. The latch 38 includes an aperture for accepting the post 36. The latch 38 is rotatable about the post 36 between an open position (as shown in FIGS. 2 and 4) and a closed position (as shown in FIG. 3).

The latch 38 includes a locking arm 40 and a spring arm 42. The locking arm 40 and the spring arm 42 are joined together proximate the aperture. The locking arm 40, when in the open position, extends away from the first arm 12 in the direction of the second arm 14. Preferably, the locking arm 40 includes a ramped surface 44 which sits flush with a side wall 46 of the second arm 14 when the latch 38 is in the closed position. The locking arm 40 also includes a contact surface 50 which contacts the barrel 20 of the door handle 16 when the security door block 16 is being installed on the door handle 16, as will be described below in greater detail. Preferably, the contact surface 50 faces away from the spanning portion 30 when the security door block 10 is in the closed position. Preferably, the contact surface 50 is flush with—or lies in the same plane as—the latch wall 34 when the latch 38 is in the open position.

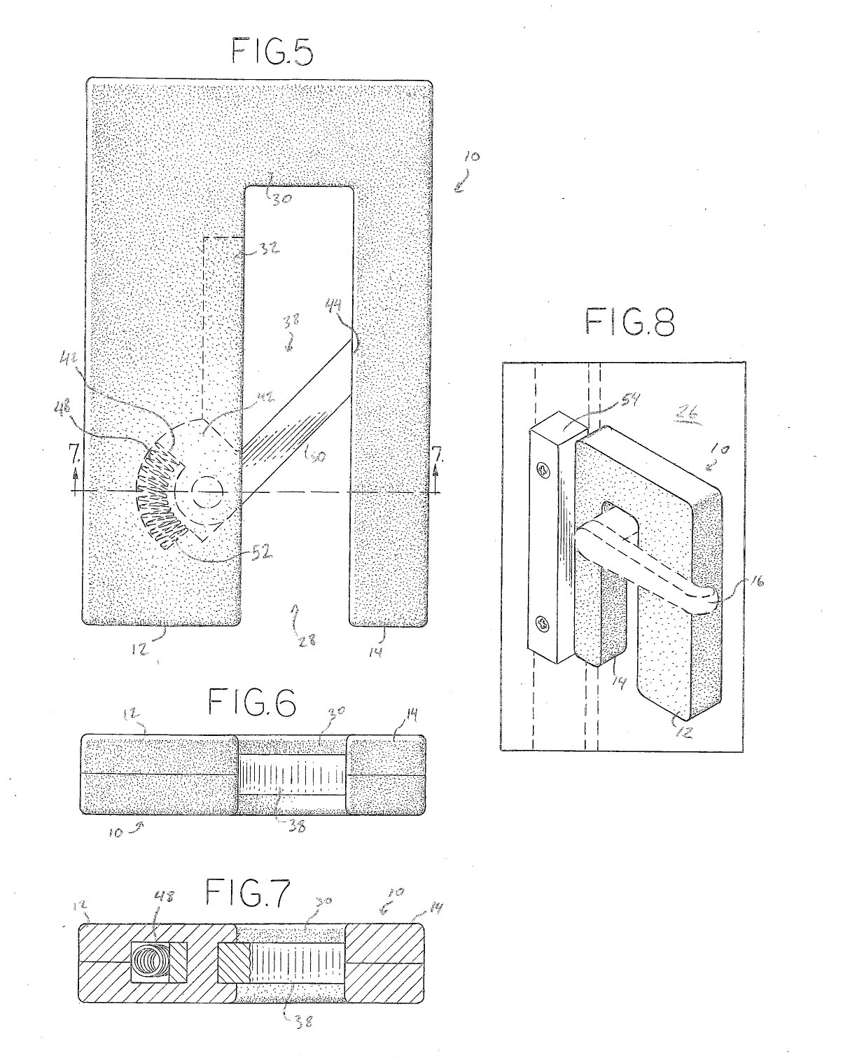

A portion of the cavity 32 is defined by a stop 52. The stop 52 is a portion of the wall which defines the cavity 32, wherein the stop 52 stands proud from the balance of the wall which defines the cavity 32, as shown in FIG. 5.

Referring to FIG. 5, a spring 48 is carried in the cavity 32 with a first end of the spring 48 in biased contact with the stop 52 and the second end of the spring 48 in biased contact with the spring arm 42. The spring 48 urges the latch 38 away from the first arm 12 and into contact with the second arm 14.

The security door block 10 is installed on a door handle 16 as shown in FIGS. 2, 3 and 4. In FIG. 2, the second arm 14 of the security door block 10 is positioned flush against the door jam 18 and above the door handle 16, such that the gap 28 is above the barrel 20. The security door block 10 is next advanced toward the door handle 16 such that the barrel 20 passes into the gap 28 and into contact with the contact wall 50 of the latch 38, thereby urging the latch 38 toward the open position. The security door block 10 is next advanced further until the barrel 20 contacts the spanning portion 30 and the latch 38 biases back to the closed position, thereby completing the installation of the security door block 10 on the door handle 16.

Referring to FIG. 8, in some instances, the door 26 will swing inwardly relative the room, and as such, the door jam 18 will not be suitable for being positioned adjacent the security door block 10. In such instances, a block 54 may be secured to the door jam 18, such that the second arm 14 of the security door block 10 will be positioned between the barrel 20 and the block 54 when the security door block 10 is installed on the door handle 16.

When used, the security door block 10 prevents the door handle 16 from being rotated since the first arm 12 contacts the tapered portion 24. By preventing rotation of the door handle 16, the security door block 10 is used in cases where an individual desires to barricade themselves inside a room. In one application, the security door block 10 is suitable for use in schools or other buildings during a lock down. During a lock down, a teacher, or other person, will close the door 26 and will install the security door block 10 on the handle 16 as described herein. When installed, the security door block 10 prevents rotation of the door handle 16, thereby slowing down an intruder from entering the room. Even a brief delay may be enough to dissuade the intruder from entering the room which is utilizing the security door block 10.

The security door block 10 is removed from the door handle 16 by biasing the latch 38 to the open position and then moving the security door block 10 up and away from the barrel 20 until the barrel clears the latch 38, at which point the latch 38 is free to bias back to the closed position and the security door block 10 is removed from the door handle 16, returning the door handle 16 to the proper function.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A security door block comprising:
a first arm, the first arm having a latch wall,
a second arm,
a gap is defined as the space between the first arm and the second arm,
a spanning portion joins the first arm to the second arm, the first arm and the second arm are oriented parallel relative one another, the spanning portion is oriented perpendicularly relative the first arm and the second arm,
a cavity is defined within the first arm and defines an opening in the latch wall,
a stop forms a portion of the wall which defines the cavity,
a post is positioned within the cavity,
a latch is carried on the post and pivotable between an open position and a closed position, the latch includes an aperture for accepting the post, the latch includes a spring arm and a locking arm, the latch includes a contact surface, with the latch in the closed position the contact surface is in the same plane as the latch wall, and
a spring is in biased contact with the stop and the spring arm, the spring urges the latch toward the closed position.
